(19) United States
(12) Patent Application Publication
(10) Pub. No.: US 2024/0259766 A1
(43) Pub. Date: Aug. 1, 2024

(54) GROUP MANAGEMENT PROTOCOL FOR IoT DEVICES

(71) Applicant: Hewlett Packard Enterprise Development LP, Spring, TX (US)

(72) Inventors: Yaohua Hu, Beijing (CN); Guo Xiao, Beijing (CN)

(21) Appl. No.: 18/102,509

(22) Filed: Jan. 27, 2023

(51) Int. Cl. H04W 4/06; H04W 24/10; H04W 76/14

(52) U.S. Cl. CPC H04W 4/06; H04W 24/10; H04W 76/14; H04W 88/08

(57) ABSTRACT

One aspect can provide a system and method for managing Internet of Things (IoT) devices. During operation, an access point (AP) can establish a wireless communication link with an IoT device, transmit a management-mode-enable signal indicating a management identifier associated with the AP to the IoT device, and place the IoT device in a group-management mode to scan nearby APs. In response to receiving, from the IoT device, a response indicating the management identifier, the AP can add the IoT device to a management group associated with the AP. The AP can further broadcast, to a plurality of IoT devices belonging to the management group, a management-request packet specifying a management operation and receive, from an IoT device belonging to the management group, a management-response packet confirming execution of the management operation specified by the management-request packet.

### BACKGROUND

### Field

This disclosure is generally related to the management of Internet of things (IoT) devices. More specifically, this disclosure is related to a novel management protocol that allows a single access point (AP) to simultaneously manage multiple IoT devices.

### BRIEF DESCRIPTION OF THE FIGURES

FIG. 1 illustrates an example of an Internet of Things (IoT) network, according to one aspect of the instant application.

FIG. 2 illustrates an example of a protocol data unit (PDU) of a management-request packet, according to one aspect of the instant application.

FIG. 3 illustrates an example of a protocol data unit (PDU) of a management-response packet, according to one aspect of the instant application.

FIG. 4 presents a flowchart illustrating an example of a process performed by an IoT device, according to one aspect of the instant application.

FIG. 5 presents a flowchart illustrating an example of a process performed by an access point (AP), according to one aspect of the instant application.

FIG. 6 illustrates a block diagram of an access point, according to one aspect of the instant application.

FIG. 7 illustrates a block diagram of an Internet of Things (IoT) device, according to one aspect of the instant application.

FIG. 8 illustrates an example of a computer system that facilitates the group management of IoT devices, according to one aspect of the instant application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the scope of the present disclosure is not limited to the embodiments shown but is to be accorded the widest scope consistent with the principles and features disclosed herein.

The proliferation of Internet of things (IoT) devices has created new challenges for network administrators. Managing IoT devices, especially Bluetooth Low Energy (BLE) IoT devices, often require that a point-to-point (P2P) connection is established between each IoT device and the management entity to allow the management entity to send management information to each IoT device. However, establishing P2P connections with IoT devices one by one can be inefficient, especially for large-scale commercial IoT applications. For example, to configure a BLE IoT device, an administrator may need to bring a gateway device (e.g., a handheld device such as a smartphone or tablet computer) to the vicinity of the BLE IoT device to allow a P2P link between the IoT device and the gateway device to be established. Configuration files or reset commands can be sent to the IoT device via the P2P link. After one IoT device is configured, the administrator may need to manually disconnect the IoT device and then connect another IoT device to the gateway device in order to configure the other IoT device. Configuring multiple IoT devices will require that P2P connections between each IoT device and the gateway device be established (sometimes manually) one by one, which can be cumbersome and time-consuming.

Although the primary function of Wi-Fi access points (APs) is to provide secure wireless network access, Bluetooth radios included in newer generation APs have expanded the functions of the APs to include the management of BLE IoT devices. Bluetooth-enabled APs can communicate directly with the BLE IoT devices, thus eliminating the need to bring the gateway devices on-site and enabling remote configuration. To further improve the device management efficiency and reduce bandwidth usage, according to some aspects of the instant application, each AP can be responsible for managing multiple BLE IoT devices and, instead of sending management messages to the IoT devices via individual P2P links, the AP can broadcast the management messages to all managed IoT devices. More specifically, the AP and the IoT devices can communicate with each other according to a new management protocol, which can allow management messages to be sent to IoT devices via point-to-multipoint (PMP) links.

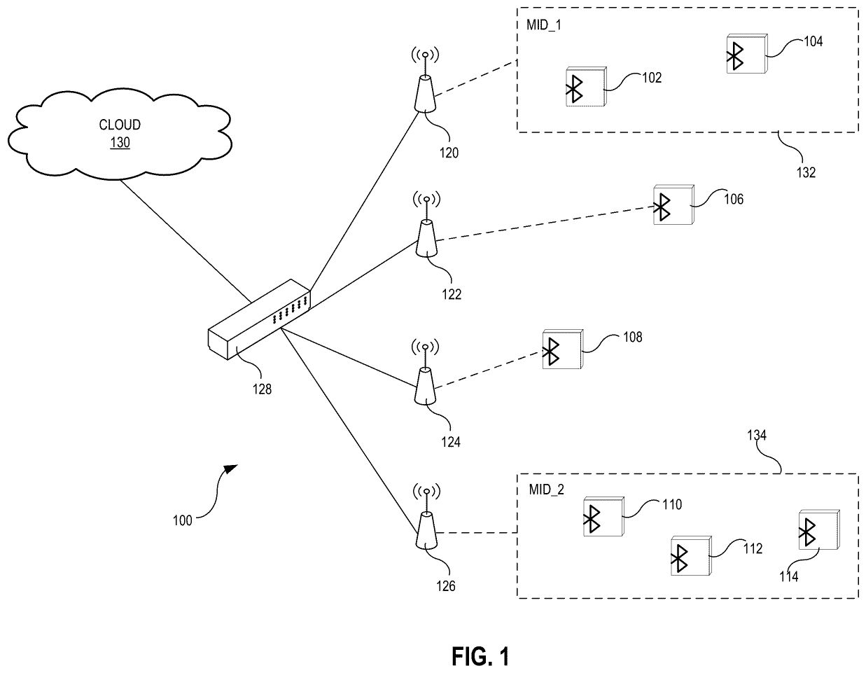

FIG. 1 illustrates an example of an Internet of Things (IoT) network, according to one aspect. In FIG. 1, an IoT network 100 can include a plurality of IoT devices (e.g., devices 102-114) and a plurality of APs (e.g., APs 120-126) providing network access services to these IoT devices. The APs can be coupled to a switch 128, which can function as a gateway between IoT network 100 and cloud 130. An IoT-management platform (not shown in FIG. 1) can reside in cloud 130, and a network administrator can remotely manage the IoT devices using the IoT-management platform.

In the example shown in FIG. 1, each AP can manage a number of IoT devices that form a management group. For example, AP 120 can manage IoT devices 102 and 104, which form a management group 132, and AP 126 can manage IoT devices 110, 112, and 124, which form a management group 134. Note that the IoT devices managed by APs 122 and 124 also form their own management groups that are elaborated here. Each AP and its corresponding management group can be associated with a unique management identifier (MID). In the example shown in FIG. 1, AP 120 and IoT devices 102 and 104 can be associated with MID_1, and AP 126 and IoT devices 110-114 can be associated with MID_2.

The formation of the management groups and the use of the AP-specific MIDs can allow each AP to manage multiple IoT devices simultaneously. More specifically, instead of establishing individual (e.g., P2P) connections with the IoT devices, an AP (or more particularly, the BLE chip included in the AP) can broadcast (e.g., via PMP links) management-request messages in the form of BLE advertising packets. In order to receive the broadcast messages from the APs, the BLE IoT devices within network 100 can be configured to enter the scanning mode (i.e., to periodically scan for nearby devices). During operation, each AP can broadcast to IoT network 100 a management-request message carrying the AP's MID, and IoT devices within a corresponding management group (i.e., as defined by the MID) can receive the management-request message and execute the management command specified by the management message. Subsequent to the execution, an IoT device can broadcast a management-response message in the form of an advertising packet, indicating to the managing AP that the management command has been executed on this IoT device.

A BLE device may operate in different modes, including the advertising mode, the scanning mode, the master-device mode, and the slave-device mode. While operating in the advertising mode, the BLE device can periodically transmit advertising information (e.g., in the form of advertising packets) and may respond with more information upon request from other devices (e.g., in the form of scan-response packets). While operating in the scanning mode, the BLE device can listen to advertising information transmitted by other devices and request additional information (e.g., by sending scan-request packets). When a P2P connection is established between two BLE devices, one device (typically the scanner device) assumes the role of a master device and the other device (typically the advertiser) becomes a slave device.

According to some aspects of the instant application, to facilitate an AP to manage multiple BLE IoT devices efficiently, the communication between the AP and the BLE IoT devices can be governed by a novel group-management protocol built upon the Bluetooth Generic Access Profile (GAP) protocol. The GAP protocol controls the BLE device-discovery process and determines how BLE devices can interact with each other. According to GAP, a device can advertise its presence by broadcasting air packets (referred to as advertising packets) to the surrounding environment. There is no pairing (i.e., establishing the P2P connection) needed for broadcasting. GAP protocol also defines the format of the advertising and the scan-request/response packets. The protocol data unit (PDU) of a typical advertising packet can have a fixed-length header and a variable-length payload.

According to some aspects, the APs and the BLE IoT devices can use the GAP advertising packets to exchange information needed for the management of the BLE IoT devices, thus eliminating the need to establish P2P connections. The management information can be embedded in the payload of the GAP advertising packets sent by the APs and the IoT devices. More specifically, advertising packets sent by the management entity (e.g., an AP) can be referred to as management-request packets, and advertising packets sent by the IoT devices can be referred to as management-response packets.

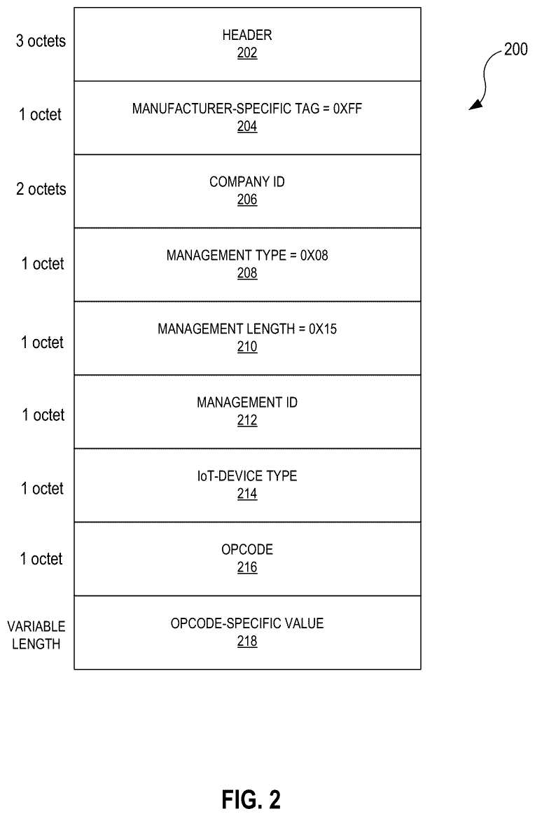

FIG. 2 illustrates an example of a protocol data unit (PDU) of a management-request packet, according to one aspect. Management-request PDU 200 can include a number of fields, including a header field 202, a manufacturer-specific tag field 204, a company-ID field 206, a management-type field 208, a management-length field 210, a management ID (MID) field 212, an IoT-device-type field 214, an operation code (opcode) field 216, and an opcode-specific value field 218. According to one aspect, management-request PDU 200 can be part of a GAP advertising packet.

Header field 202 can be three octets long and similar to a standard GAP header. Manufacturer-specific tag field 204 can be one octet long. In this example, manufacturer-specific tag field 204 is assigned a value of 0XFF to indicate that PDU 200 is specific to a particular manufacturer. Company-ID field 206 can be two octets long and can include the Bluetooth registered company ID of that particular manufacturer. In this example, the company ID can be the Bluetooth registered identifier of the manufacturer of the AP implementing this novel group-management protocol.

Management-type field 208 can be one octet long, with an assigned value of 0X08 to indicate that PDU 200 belongs to a management-request packet advertised by an AP. Management-length field 208 can be one octet long. In this example, management-length field 208 can include a value of 0X15, indicating that the data (or actual payload) field of PDU 200 can be 21 octets long.

The actual payload of PDU 200 includes MID field 212, IoT-device-type field 214, opcode field 216, and opcode-specific value field 218. MID field 212 can be one octet long and can include an AP-specific MID. Note that each and every management-request packet sent by a particular AP carries an MID that has been uniquely assigned (e.g., by the cloud-based IoT-management platform) to that particular AP. IoT-device-type field 214 can be one octet long and can include a device type specifying the type of device targeted by the management-request packet. Only the IoT devices with a matching MID and device type will receive and process the management-request packet.

Opcode field 216 can be one octet long and can include an opcode specifying a management command. The management command can be associated with a certain type of management operation. In one example, different opcodes can correspond to different management operations, including but not limited to: a resetting operation (opcode=1), an operation to adjust the transmitter power (opcode=2), an operation to change the universally unique identifier (UUID) of the IoT device (opcode=3), an operation to place the IoT device in a sleep mode (opcode=4), an upgrade operation (opcode=5), etc. Note that an opcode with a zero value indicates that no management operation is requested. Opcode-specific value field 218 can have a variable length and can include the value that is relevant to the management operation specified by the opcode. For example, if the opcode specifies that the management operation is to adjust the transmitter power (opcode=2), then opcode-specific value field 218 can include a value indicating the adjusted power of the transmitter; if the opcode specifies that the management operation is to change the UUID (opcode=3) of the IoT device, then opcode-specific value field 218 can include the new UUID. In another example, if the opcode specifies that the management operation is to upgrade the IoT device (opcode=5), which requires a series of packets containing the configuration file to be sent to the IoT device, opcode-specific value field 218 can include the sequence numbers of those packets.

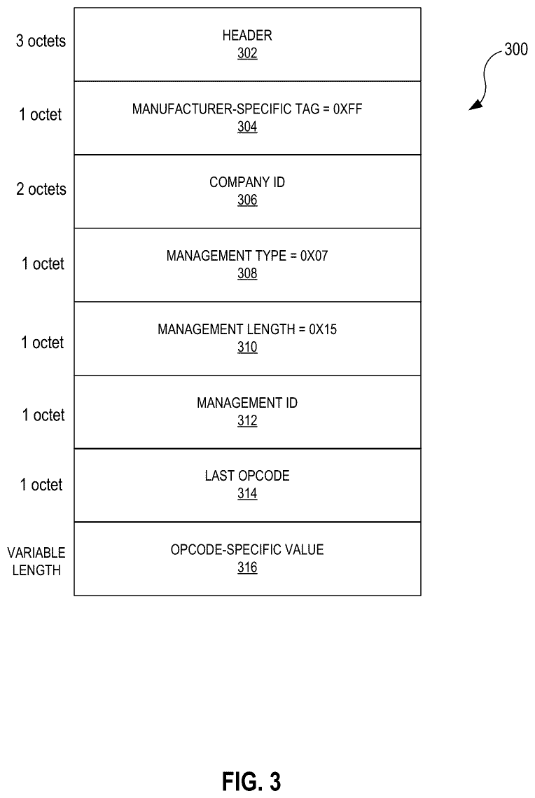

FIG. 3 illustrates an example of a protocol data unit (PDU) of a management-response packet, according to one aspect. Management-response PDU 300 can include a number of fields, including a header field 302, a manufacturer-specific tag field 304, a company-ID field 306, a management-type field 308, a management-length field 310, a management ID (MID) field 312, a last-opcode field 314, and an opcode-specific value field 316.

Header field 302, manufacturer-specific tag field 304, and company-ID field 306 can be similar, respectively, to fields 202, 204, and 206 shown in FIG. 2. Management-type field 308 can be one octet long, with an assigned value of 0X07 to indicate that PDU 300 belongs to a management-response packet advertised by a BLE IoT device. Management-length field 308 can be similar to management-length field 208. In this example, management-length field 308 is one octet long with a value of 0X15.

MID field 312 can be one octet long and can include the MID of the management group to which the BLE IoT device belongs. Only the AP with a matching MID will receive and process the management-response packet. Last-opcode field 314 can include an opcode corresponding to the last (or the most recent) operation command executed by the IoT device. For example, if the last management operation performed by the IoT device is device upgrading, the opcode included in last-opcode field 314 can be 5; if the last management operation performed by the IoT device is resetting, the opcode included in last-opcode field 314 can be 1. Opcode-specific value field 316 can include information related to the last management operation performed by the IoT device. For example, if the last management operation performed by the IoT device is modifying the UUID, opcode-specific value field 316 can include the current UUID of the IoT device. In another example, the last management operation is the device upgrade operation, and opcode-specific value field 316 can include the sequence numbers of the received configuration packets.

Note that, to conserve power, most BLE IoT devices do not operate in the scanning mode by default. According to some aspects of the instant application, when a BLE IoT device is deployed in the field, it needs to be configured by an AP via a P2P connection between the AP and the IoT device. More specifically, this initial configuration can include the AP sending the IoT device a group-management-mode-enable signal to place the IoT device in a group-management mode (or enable a group-management function on the BLE IoT device). When operating in the group-management mode, the BLE IoT device can periodically perform scanning for nearby devices (i.e., APs).

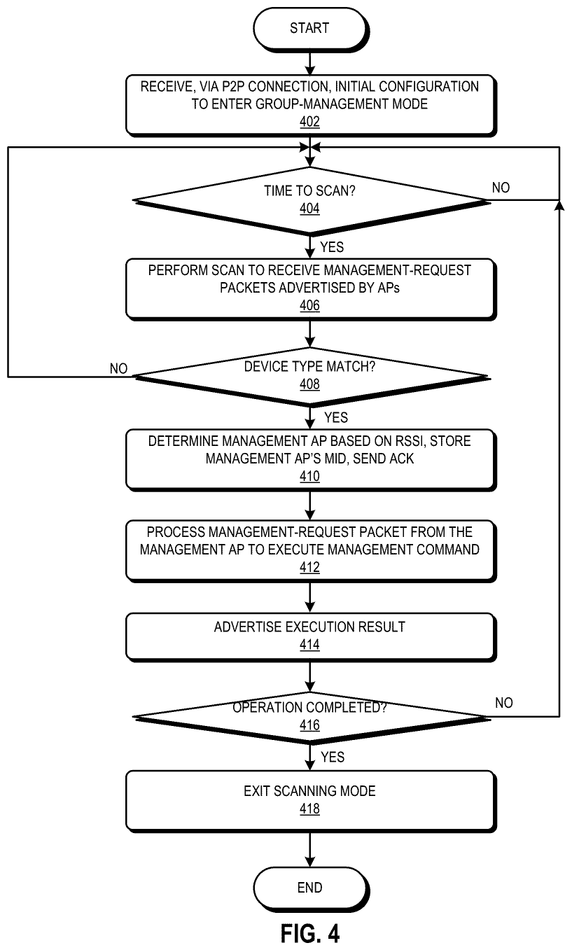

FIG. 4 presents a flowchart illustrating an example of a process performed by an IoT device, according to one aspect. During operation, the IoT device can first receive, via a P2P connection established between a management entity (e.g., an AP) and the IoT device the initial configuration, which causes the IoT device to enter the group-management mode (operation 402). The IoT device can be deployed to the field once the initial configuration is completed. The P2P connection between the IoT device and the management entity can be established using a process similar to the one used by existing BLE solutions. According to some aspects, once the P2P connection is established, the management entity can send an enable signal to the IoT device to place the IoT device in the group-management mode. When operating in the group-management mode, the Bluetooth radio of the IoT device periodically scans for nearby devices. In addition to the enable signal, a set of scan parameters (e.g., scan intervals and/or duration of each scan) can also be sent to the IoT device by the management entity. In one example, the management entity can be an AP, and information associated with the AP (e.g., the AP-specific MID and a device filter specifying the type of device to be managed by the AP) can also be sent to the IoT device to allow the IoT device to choose this AP as its initial management AP. If the IoT device subsequently roams to a faraway location, the IoT device may select a different AP with a better received signal strength indicator (RSSI) value as its management AP.

Subsequent to entering the group-management mode, the IoT device waits for the arrival of the time to scan based on the received scan interval (operation 404). In one example, the scan interval may be determined based on a scheduled maintenance time. When it is time to scan, the IoT device performs the scan to receive management-request packets broadcasted/advertised by nearby APs (operation 406). The PDUs of the management-request packets be similar to the one shown in FIG. 2. For each received management-request packet, the IoT device can determine whether the device type specified in the packet matches its own device type (operation 408). If not, the packet is ignored, and the IoT device waits for the next scan (operation 404). For example, a temperature sensor can ignore management-request packets intended for light sensors, and vice versa. For management-request packets with a matching device type, the IoT device can select, based on the RSSI values associated with the APs advertising those packets, an AP with the best RSSI as the management AP, store the MID (which is included in the management-request packet) of the selected AP, and send an acknowledgment (ACK) packet to the selected AP (operation 410). The ACK packet indicates to the selected AP that the IoT device is now part of its management group.

In certain situations, the scan performance of the BLE IoT device may be less than ideal. For example, the wireless link between the IoT device and the AP can be slow due to congestion or interference. According to some aspects, while operating in the group-management mode, the IoT device can be configured only to scan (or listen for advertising packets from) the group manager (i.e., the AP with a matching MID). The IoT device can ignore other APs or IoT devices in its surrounding, thus improving the scan performance.

The IoT device can subsequently process the management-request packet from the management AP to execute the management command specified in the management-request packet (operation 412). As shown in FIG. 2, the management-request packet includes an opcode field specifying a management command. Examples of the management command can include but are not limited to: resetting, adjusting the transmitter power, modifying the UUID, placing the IoT device in a sleep mode, upgrading, etc. Subsequent to executing the management operation, the IoT device can advertise the execution result by broadcasting a management-response packet (operation 414). The management-response packet can have a format similar to the one shown in FIG. 3.

The IoT device can then determine whether the management operation has been completed (operation 416). Note that executing certain management commands may also include receiving additional packets from the management AP. For example, the upgrading operation requires that the IoT device receive a configuration file, which can include multiple (e.g., tens or hundreds of) packets, from the management AP. The IoT device can perform the upgrade operation after all packets of the configuration file have been received. If the management operation is not yet completed, the IoT device needs to remain in the scanning mode to ensure that all packets needed for the management operation can be received (operation 404). If the management operation is completed, the IoT can exit the scanning mode to conserve power (operation 418).

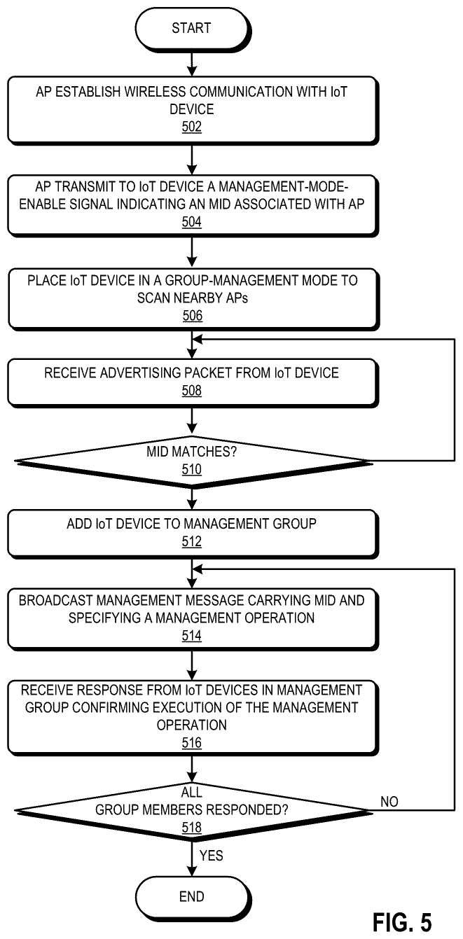

FIG. 5 presents a flowchart illustrating an example of a process performed by an access point (AP), according to one aspect. During operation, an AP establishes a wireless communication link with an IoT device (operation 502). According to some aspects, the wireless communication link can be a Bluetooth P2P connection established according to the BLE GAP protocol. The AP can transmit to the IoT device a group-management-mode-enable signal indicating an MID associated with the AP (operation 504) and place the IoT device in the group-management mode to scan nearby APs (operation 506). When operating in the group-management mode, the IoT device can periodically perform a scan to receive advertising packets from nearby APs. In addition to the AP's MID, parameters associated with the scan (e.g., the scan interval and/or the duration of each scan) can be sent to the IoT device along with the group-management-mode-enable signal via the P2P connection between the AP and the IoT device.

The AP can receive an advertising packet from a nearby IoT device (operation 508). More specifically, the AP has been configured to operate in the scanning mode such that its Bluetooth radio can listen to advertising packets transmitted by nearby devices. Each advertising packet can carry the MID of the management group to which the transmitting IoT device belongs. The receiving AP can determine whether the MID included in the received packet matches its own MID (operation 510). If not, the AP can ignore the packet and receive additional advertising packets (operation 508). If the MID in the received packet matches the AP's MID, the AP can add the transmitting IoT device to its management group (operation 512). The management group typically can include multiple IoT devices of the same type, and the AP can simultaneously manage the IoT devices in its management group (e.g., by sending a management-request via PMP links between the AP and the IoT devices).

The AP can broadcast a management-request packet carrying the AP's MID and specifying a management operation (operation 514). The format of the management-request packet can be similar to the one shown in FIG. 2. The management operation can be specified by the opcode included in the management-request packet. Examples of the IoT management operation can include but are not limited to: resetting the device, adjusting the transmitter power, modifying the UUID, placing the IoT device in a sleep mode, upgrading the IoT device, etc. According to some aspects, each AP may receive, from the cloud-based management platform, a request to perform a management operation on its managed IoT devices and then broadcast the management-request packet accordingly.

The AP can receive, from the IoT devices in its management group, management-response packets confirming the execution of the management operation (operation 516). More specifically, each IoT device can advertise the management-response packet once it starts to execute the management operation. According to one aspect, the management-response packet can include the execution result. The AP can then determine whether all IoT devices in its management group have responded (operation 518). If so, the AP has successfully performed a management operation on all IoT devices in its management group (e.g., upgraded all IoT devices), and the process ends. If not, the AP can re-broadcast the management-request packet (operation 514). Note that IoT devices that have completed the management operation will not receive the re-broadcasted management-request packet as they have exited the scanning mode. The entire process may time out after a predetermined duration or after a predetermined number of management-request packets have been transmitted, even if the AP has not received the management-response packet from all IoT devices in the management group. This can prevent the situation where a malfunctioned IoT device causes never-ending re-broadcast.

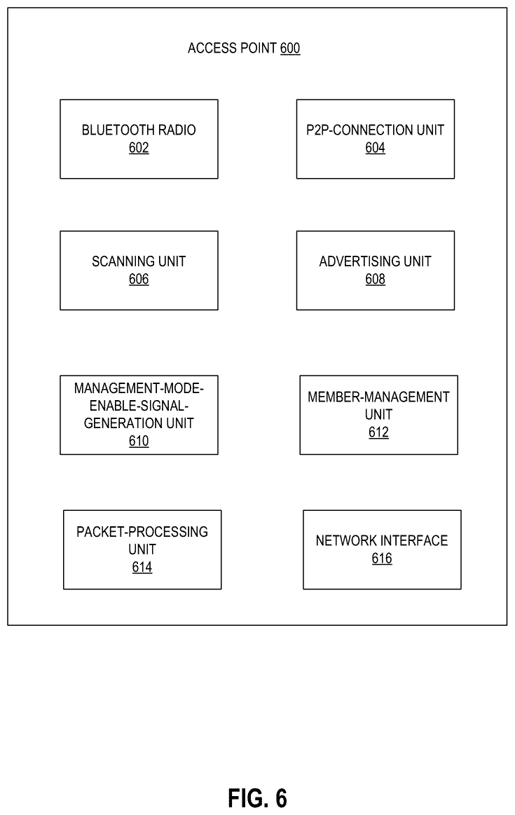

FIG. 6 illustrates a block diagram of an access point, according to one aspect. Access point (AP) 600 can include a Bluetooth radio 602, a P2P-connection unit 604, a scanning unit 606, an advertising unit 608, a group-management-mode-enable-signal-generation unit 610, a member-management unit 612, a packet-processing unit 614, and a network interface 616.

Bluetooth radio 602 can send and receive air packets, including the management-request packets and the management-response packets. Bluetooth radio 602 can also receive other standard BLE packets, such as the BLE advertising packets and the BLE data packets.

P2P-connection unit 604 can facilitate the establishment of the P2P connections between AP 600 and nearby BLE IoT devices. P2P-connection unit 604 can use a standard BLE connection-establishment process (e.g., a process defined by the GAP protocol) to establish a P2P connection between AP 600 and a nearby BLE IoT device. According to some aspects, the initial configuration of the IoT device is performed via the P2P connection, over which AP 600 can send a group-management-mode-enable signal along with a set of scan parameters (e.g., the scan interval and/or the duration of each scan) to the connected IoT device.

Scanning unit 606 can scan for nearby Bluetooth devices (e.g., nearby BLE IoT devices). According to some aspects, scanning unit 606 can periodically perform the scan based on a predetermined scan interval and or scan duration, both of which can be configured by the network administrator via a cloud-based management platform.

Advertising unit 608 can be responsible for generating advertising packets to be broadcasted by AP 600. According to some aspects, advertising unit 608 can generate the to-be-advertised or broadcasted management-request packets based on the novel group-management protocol. For example, the PDU of the management-request packets can be similar to the one shown in FIG. 2. Advertising unit 608 can include, in the management-request packets, the MID associated with AP 600, such that only the IoT devices in its management group will receive and process these management-request packets. Other management information (e.g., the type of the managed devices and the to-be-executed management operation, etc.) can also be included in the management-request packets.

Group-management-mode-enable-signal-generation unit 610 can be responsible for generating a group-management-mode-enable signal, which is sent to a BLE IoT device via a P2P connection between AP 600 and the BLE IoT device. The group-management-mode-enable signal can cause the received BLE IoT device to enter the group-management mode (i.e., to start the periodic scan of the nearby devices). Member-management unit 612 can be responsible for maintaining a member list. According to some aspects, an IoT device can be to the member list of AP 600 if an advertising packet sent by the IoT device includes the MID of AP 600.

Packet-processing unit 614 can be responsible for processing received packets. Advertising packets received during scanning can be processed by packet-processing unit 614. According to some aspects, packet-processing unit 614 can process a received management-response packet by comparing the MID in the received packet with the MID of AP 600. If the two MIDs do not match, packet-processing unit 614 can ignore the received packet. If the two MIDs match, packet-processing unit 614 can extract and process data fields included in the received packet (e.g., to determine the last management operation performed by the IoT device based on the opcode included in the packet).

Network interface 616 can allow AP 600 to interface with the network (e.g., via a switch) to receive management commands and configuration files from the cloud-based management platform. AP 600 can also include other types of functional blocks or units that can facilitate AP 600 in providing wireless network access services to devices coupled to AP 600.

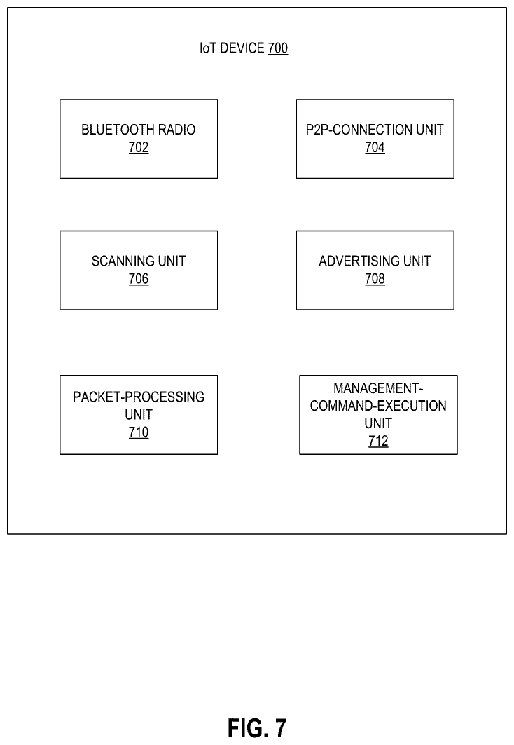

FIG. 7 illustrates a block diagram of an Internet of Things (IoT) device, according to one aspect. IoT device 700 can include a Bluetooth radio 702, a P2P-connection unit 704, a scanning unit 706, an advertising unit 708, a packet-processing unit 710, and a management-command-execution unit 712.

Bluetooth radio 702 can be similar to Bluetooth radio 602 and can send and receive air packets. According to some aspects, Bluetooth radio 702 of IoT device 700 can receive management-request packets advertised by a management AP and send management-response packets to the management AP. P2P-connection unit 704 can facilitate the establishment of a BLE P2P connection between IoT device 700 and an AP that performs the initial configuration of IoT device 700. More specifically, the established P2P connection can be used by the AP to transmit a group-management-mode-enable signal to IoT device 700 to enable scanning unit 706.

The default setting of scanning unit 706 is off in order to conserve energy. However, when IoT device 700 receives the group-management-mode-enable signal via the P2P connection established between a nearby AP and IoT device 700, scanning unit 706 can be turned on to scan for nearby devices periodically. Performing the scan can allow IoT device 700 to receive advertising packets (e.g., the management-request packets) sent by nearby APs. According to some aspects, scanning unit 706 may detect multiple APs and can compare the RSSI of the multiple APs in order to select an AP with the best RSSI as the management AP of IoT device 706.

Advertising unit 708 can be responsible for broadcasting advertising packets such that IoT device 700 can be discoverable (e.g., by a management AP). Moreover, advertising unit 708 can generate and broadcast a management-response packet to notify the management AP of the execution of a management command or operation. The PDU of the management-response packet can be similar to the one shown in FIG. 3.

Packet-processing unit 710 can be responsible for processing received packets, such as the management-request packets. According to some aspects, packet-processing unit 710 can use a device-type filter and a MID filter to determine whether IoT device 700 is the intended target of a received management-request packet. If so, packet-processing unit 710 can process the packet by extracting data fields in the packet (e.g., to determine a management command specified by the packet). Management-command-execution unit 712 can be responsible for executing the management command specified by the management-request packet. If executing the command requires additional packets (e.g., packets carrying the configuration file for device upgrade), management-command-execution unit 712 can configure scanning unit 706 to receive the additional packets. In one example, the duration of each scan can be configured based on the number and size of the additional packets. Once management-command-execution unit 712 completes the management operation (e.g., receiving all packets included in the configuration file), management-command-execution unit 712 can configure scanning unit 706 to exit the scanning mode to conserve power.

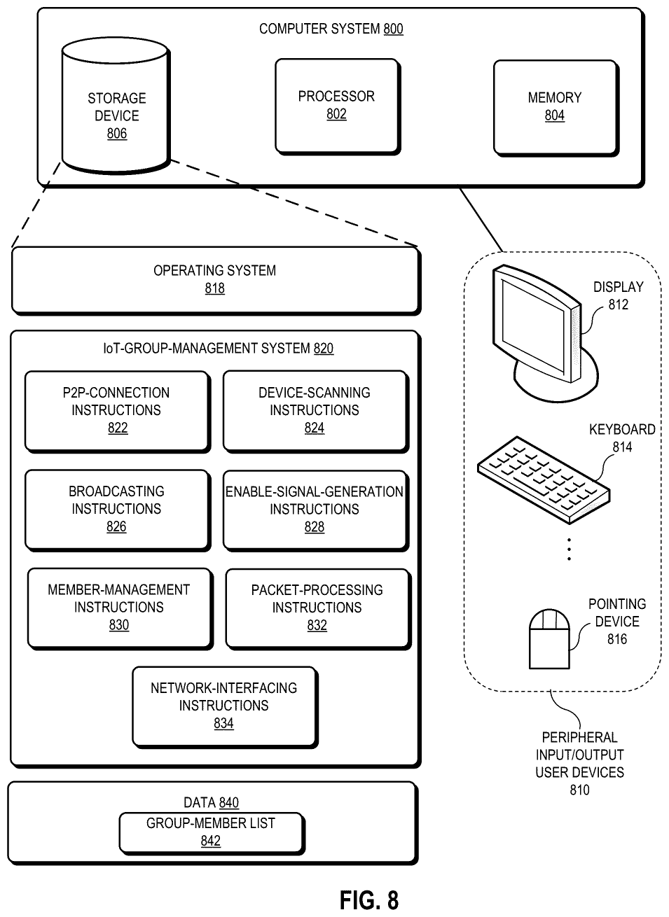

FIG. 8 illustrates an example of a computer system that facilitates the group management of the IoT devices, according to one aspect of the instant application. Computer system 800 can include a processor 802, a memory 804, and a storage device 806. Furthermore, computer system 800 can be coupled to peripheral input/output (1/O) user devices 810, e.g., a display device 812, a keyboard 814, and a pointing device 816. Storage device 806 can store an operating system 818, an IoT-group-management system 820, and data 840. According to some aspects, computer system 800 can be implemented on an AP (e.g., as a host of the IoT device).

IoT-group-management system 820 can include instructions, which when executed by computer system 800, can cause computer system 800 or processor 802 to perform methods and/or processes described in this disclosure. IoT-group-management system 820 can include instructions for communicating with IoT devices via P2P connections (P2P-connection instructions 822), instructions for scanning nearby devices (device-scanning instructions 824), instructions for broadcasting advertising packets (broadcasting instructions 826), instructions for generating the group-management-mode-enable signal (enable-signal-generation instructions 828), instructions for managing members of the management group such as maintaining a member list (member-management instructions 830), instructions for processing packets (packet-processing instructions), and instructions for implementing a network interface (network-interface instructions). Data 840 can include a group-member list.

In general, the disclosure describes a method and system for the efficient management of IoT devices via access points. More specifically, a novel group-management protocol can be implemented to allow a single AP to simultaneously manage multiple IoT devices. After an initial configuration that enables an IoT device to periodically scan for nearby devices, each IoT device can select a nearby AP (e.g., the AP with the best RSSI) as its management entity and join its management group. Each AP can broadcast management-request packets to members of its management group and receive corresponding management-response packets. Each management-request packet can carry the MID associated with the AP and specify a management operation. Each IoT device can process a received management-request packet with a matching MID (i.e., the MID in the packet matches the MID of the management group to which the IoT device belongs), execute the management operation specified by the received packet, and advertise a management-response packet carrying the MID of the management group. The corresponding AP can receive management-response packets from its group members and determine whether re-broadcasting of the management-request packet is needed. This approach allows the AP to send a management command (including the configuration file for device upgrade) to multiple recipients (i.e., IoT devices within its management group) simultaneously (e.g., by broadcasting the management-request packet). Compared with conventional approaches that rely on point-to-point connections, this novel approach uses point-to-multipoint (PMP) connections to manage IoT devices, thus significantly reducing the amount of time and bandwidth needed for the management of the IoT devices.

One aspect can provide a system and method for managing Internet of Things (IoT) devices. During operation, an access point (AP) can establish a wireless communication link with an IoT device, transmit a management-mode-enable signal indicating a management identifier associated with the AP to the IoT device, and place the IoT device in a group-management mode to scan nearby APs. In response to receiving, from the IoT device, a response indicating the management identifier, the AP can add the IoT device to a management group associated with the AP. The AP can further broadcast, to a plurality of IoT devices belonging to the management group, a management-request packet specifying a management operation and receive, from an IoT device belonging to the management group, a management-response packet confirming execution of the management operation specified by the management-request packet.

In a variation on this aspect, the managed IoT devices can include Bluetooth low-energy (BLE) IoT devices.

In a further variation, the management-request packet and the management-response packet can be advertising packets according to BLE Generic Access Profile (GAP) protocol.

In a variation on this aspect, transmitting the management-mode-enable signal can further include transmitting a set of scan parameters comprising a scan interval to the IoT device.

In a further variation, placing the IoT device in the group-management mode can cause the IoT device to perform periodic scans based on the set of scan parameters and select, based on received signal strength indicator (RSSI) values associated with the nearby APs, an AP as a management AP.

In a further variation, placing the IoT device in the group-management mode can further cause the IoT device to receive a management-request packet from the management AP, execute the management operation specified by the management-request packet received from the management AP, and broadcast the management-response packet. The management-response packet comprises an MID of the management AP and execution result of the management operation.

In a variation on this aspect, the management-request packet can specify a device type.

In a variation on this aspect, in response to determining that the management-response packet from at least one IoT device in the management group is not received, the AP can re-broadcast the management-request packet.

In a variation on this aspect, the management operation can include one of: resetting the IoT device, adjusting the IoT device's transmitting power, modifying the IoT device's universally unique identifier (UUID), placing the IoT device in a sleep mode, and upgrading the IoT device.

In a variation on this aspect, establishing the wireless communication link with the IoT device comprises establishing a Bluetooth point-to-point connection between the AP and the IoT device.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware devices or apparatus. The hardware devices or apparatus can include, but are not limited to, application-specific integrated circuit (ASIC) chips, field-programmable gate arrays (FPGAs), dedicated or shared processors that execute a particular software unit or a piece of code at a particular time, and other programmable-logic devices now known or later developed. When the hardware devices or apparatus are activated, they perform the methods and processes included within them.

The foregoing descriptions of embodiments have been presented for purposes of illustration and description only. They are not intended to be exhaustive or to limit the scope of this disclosure to the forms disclosed. Accordingly, many modifications and variations will be apparent to practitioners skilled in the art.

What is claimed is:

1. A method for managing Internet of Things (IoT) devices, the method comprising:
establishing, by an access point (AP), a wireless communication link with an IoT device;
transmitting, to the IoT device, a management-mode-enable signal indicating a management identifier associated with the AP;
placing the IoT device in a group-management mode to scan nearby APs;
in response to receiving, from the IoT device, a response indicating the management identifier, adding the IoT device to a management group associated with the AP;
broadcasting, to a plurality of IoT devices belonging to the management group, a management-request packet specifying a management operation; and
receiving, from an IoT device belonging to the management group, a management-response packet confirming execution of the management operation specified by the management-request packet.

2. The method of claim 1, wherein the managed IoT devices comprise Bluetooth low-energy (BLE) IoT devices.

3. The method of claim 2, wherein the management-request packet and the management-response packet are advertising packets according to BLE Generic Access Profile (GAP) protocol.

4. The method of claim 1, wherein transmitting the management-mode-enable signal further comprises transmitting a set of scan parameters comprising a scan interval to the IoT device.

5. The method of claim 4, wherein placing the IoT device in the group-management mode causes the IoT device to:
perform periodic scans based on the set of scan parameters; and
select, based on received signal strength indicator (RSSI) values associated with the nearby APs, an AP as a management AP.

6. The method of claim 5, wherein placing the IoT device in the group-management mode further causes the IoT device to:
receive a management-request packet from the management AP;
execute the management operation specified by the management-request packet received from the management AP; and
broadcast the management-response packet, wherein the management-response packet comprises an MID of the management AP and execution result of the management operation.

7. The method of claim 1, wherein the management-request packet specifies a device type.

8. The method of claim 1, further comprising:
in response to determining that the management-response packet from at least one IoT device in the management group is not received, re-broadcasting the management-request packet.

9. The method of claim 1, wherein the management operation comprises one of:
resetting the IoT device;
adjusting the IoT device's transmitting power;
modifying the IoT device's universally unique identifier (UUID);
placing the IoT device in a sleep mode; and
upgrading the IoT device.

10. The method of claim 1, wherein establishing the wireless communication link with the IoT device comprises establishing a Bluetooth point-to-point connection between the AP and the IoT device.

11. A wireless access point (AP), the AP comprising:
a processor;
a memory storing instructions that when executed by the processor cause the processor to perform a method for managing Internet of Things (IoT) devices, the method comprising:
establishing, by the access point (AP), a wireless communication link with an IoT device;
transmitting, to the IoT device, a management-mode-enable signal indicating a management identifier associated with the AP;
placing the IoT device in a group-management mode to scan nearby APs;
in response to receiving, from the IoT device, a response indicating the management identifier, adding the IoT device to a management group associated with the AP;
broadcasting, to a plurality of IoT devices belonging to the management group, a management-request packet specifying a management operation; and
receiving, from an IoT device belonging to the management group, a management-response packet confirming execution of the management operation specified by the management-request packet.

12. The wireless AP of claim 11, wherein the managed IoT devices comprise Bluetooth low-energy (BLE) IoT devices.

13. The wireless AP of claim 12, wherein the management-request packet and the management-response packet are advertising packets according to BLE Generic Access Profile (GAP) protocol.

14. The wireless AP of claim 11, wherein transmitting the management-mode-enable signal further comprises transmitting a set of scan parameters comprising a scan interval to the IoT device.

15. The wireless AP of claim 14, wherein placing the IoT device in the group-management mode causes the IoT device to:
perform periodic scans based on the set of scan parameters; and
select, based on received signal strength indicator (RSSI) values associated with the nearby APs, an AP as a management AP.

16. The wireless AP of claim 15, wherein placing the IoT device in the group-management mode further causes the IoT device to:
receive a management-request packet from the management AP;
execute the management operation specified by the management-request packet received from the management AP; and
broadcast the management-response packet, wherein the management-response packet comprises an MID of the management AP and execution result of the management operation.

17. The wireless AP of claim 11, wherein the management-request packet specifies a device type.

18. The wireless AP of claim 11, wherein the method further comprises:
in response to determining that the management-response packet from at least one IoT device in the management group is not received, re-broadcasting the management-request packet.

19. The wireless AP of claim 11, wherein the management operation comprises one of:
resetting the IoT device;
adjusting the IoT device's transmitting power;
modifying the IoT device's universally unique identifier (UUID);
placing the IoT device in a sleep mode; and
upgrading the IoT device.

20. The wireless AP of claim 11, wherein establishing the wireless communication link with the IoT device comprises establishing a Bluetooth point-to-point connection between the AP and the IoT device.
